(19) United States
(12) Patent Application Publication
(10) Pub. No.: US 2020/0308908 A1
(43) Pub. Date: Oct. 1, 2020

(54) ROMAN SHADE FOR ODD SHAPED AND/OR NON-VERTICAL WINDOWS

(71) Applicant: Crestron Electronics, Inc., Rockleigh, NJ (US)

(72) Inventor: Michael Campagna, Woodcliff Lake, NJ (US)

(73) Assignee: Crestron Electronics, Inc., Rockleigh, NJ (US)

(21) Appl. No.: 16/822,382

(22) Filed: Mar. 18, 2020

Related U.S. Application Data
(60) Provisional application No. 62/824,345, filed on Mar. 27, 2019.

(51) Int. Cl. E06B 9/58; E06B 9/327

(52) U.S. Cl. CPC E06B 9/58; E06B 2009/583; E06B 9/327

(57) ABSTRACT

A roman shade for covering a structural opening comprising a tube adapted to be installed proximate to the top of the structural opening, a shade material having a first end attached proximate to the top of the structural opening, a pair of tracks each adapted to follow a contour of and be attached along one of the sides of the structural opening, a pair of master carriers attached to opposite sides of and proximate to the second end of the shade material and each adapted to travel within one of the tracks, a pair of cords each having a first end attached to the tube and a second end attached to one of the pair of master carriers, and a shade drive unit operably connected to the tube and adapted to rotate the tube to wind or unwind the pair of cords and thereby lift or lower the pair of master carriers within the pair of tracks.

### BACKGROUND OF THE INVENTION

### Technical Field

Aspects of the embodiments relate to shades, and more particularly to systems, methods, and modes for a roman shade for odd shaped windows, including non-rectangular windows such as trapezoidal and parallelogram windows, and which may be mounted in windows of different orientations and tilt angles.

### Background Art

Roman shades are effective in screening windows, doors, or the like, to achieve privacy and thermal effects. A roman shade typically includes a rectangular shade material, such as fabric, that generally hangs flat when the shade is in a closed position and which forms pleats at the bottom of the shade material when the shade is pulled up to an opened position. The shade material includes horizontal and evenly spaced stiffeners or dowels attached to its rear surface. Rings are attached on either side of each dowel through which a cord is looped. The cord is attached to the bottom most dowel to lift the shade material. The cord can be pulled either manually or can be attached to a rod upon which it is may be wound via an electric motor.

In a typical roman shade, the bottom end of the fabric is free hanging. In some homes and commercial buildings, windows are being installed that are angled toward or away from the room. In a typical roman shade, however, the fabric will roll up and down perpendicular to the floor or the window sill. In tilted windows, however, it is desirous to have the shade material hang and travel parallel to the window such that the fabric is sloped at the same angle as the window.

In addition, while windows are typically rectangular and positioned in a vertical orientation, some buildings employ odd shaped windows, such as trapezoidal or parallelogram windows, with tilted orientation. In such applications, typical roman shades with rectangular fabrics are inappropriate as they will not provide full coverage of the window, resulting in unsightly light gaps at the sides of the window. Conventional window shades cannot fully conform to the uniquely shape and angled windows, such as trapezoidal or parallelogram windows.

Accordingly, a need has arisen for a roman shade for a non-rectangular window, such as a trapezoidal or parallelogram window, and which may be mounted to windows of different orientations and tilt angles.

### SUMMARY OF THE INVENTION

It is an object of the embodiments to substantially solve at least the problems and/or disadvantages discussed above, and to provide at least one or more of the advantages described below.

It is therefore a general aspect of the embodiments to provide systems, methods, and modes for a roman shade for a non-rectangular window, such as a trapezoidal or parallelogram window, and which may be mounted to windows of different orientations and tilt angles.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Further features and advantages of the aspects of the embodiments, as well as the structure and operation of the various embodiments, are described in detail below with reference to the accompanying drawings. It is noted that the aspects of the embodiments are not limited to the specific embodiments described herein. Such embodiments are presented herein for illustrative purposes only. Additional embodiments will be apparent to persons skilled in the relevant art(s) based on the teachings contained herein.

### Disclosure of Invention

According to one aspect of the embodiments, a roman shade is provided adapted cover a structural opening comprising a top, a bottom, and a pair of sides. The roman shade comprises a tube adapted to be installed proximate to the top of the structural opening and a shade material comprising and extending between a first end attached proximate to the top of the structural opening and a second end, wherein the shade material comprises a size adapted to substantially cover the structural opening. The roman shade further comprises a pair of longitudinal tracks each adapted to follow a contour of and be attached along one of the sides of the structural opening, a pair of master carriers attached to opposite sides of and proximate to the second end of the shade material, wherein each master carrier is adapted to be retained by and longitudinally travel within one of the longitudinal tracks, and a pair of cords each having a first end attached to the tube and a second end attached to one of the pair of master carriers. The roman shade further comprises a shade drive unit operably connected to the tube and adapted to rotate the tube to wind or unwind the pair of cords and thereby lift or lower the pair of master carriers within the pair of tracks.

According to an embodiment, the roman shade further comprises a dowel attached horizontally proximate to the second end of the shade material and wherein the pair of master carriers are attached to opposite ends of the dowel. The dowel may be attached to the shade material via at least one selected from the group consisting of a horizontal pocket, a horizontal shroud tape, one or more strips, one or more rings, and any combinations thereof. The pair of tracks may be adapted to be mounted unparalleled with respect to each other in a structural opening in which the pair of sides are unparalleled such that the structural opening comprises a first width and a second width wider than the first width. According to an embodiment, the dowel comprises a telescoping dowel adapted to expand or compress as the master carriers travel within the pair of tracks. The telescoping dowel may comprise a first hollow rod and at least one second rod that telescopingly extends from the first hollow rod. The shade material may horizontally extend from a first width that substantially spans the first width of the structural opening to a second width that substantially spans the second width of the structural opening. The shade material may comprise a rectangular shape comprising a width that substantially spans the second width of the structural opening, and wherein the shade material is adapted to create vertical pleats as the telescoping dowel gets compressed. According to another embodiment, the shade material may comprise a stretchable material adapted to stretch out horizontally from a first width that substantially spans the first width of the structural opening to a second width that substantially spans the second width of the structural opening. According to another embodiment, the shade material may comprise vertical pleats adapted to unfold to horizontally extend the shade material from a first width that substantially spans the first width of the structural opening to a second width that substantially spans the second width of the structural opening. According to yet another embodiment, the dowel may comprise a flexible dowel adapted to bend and unbend as the master carriers travel within the pair of tracks.

According to an embodiment, each of the pair of tracks may be bent to follow the contour of one of the sides of the structural opening that has a corresponding bend. According to an embodiment, the roman shade may further comprise a head rail adapted to contain the tube and the shade drive unit, wherein the first end of the shade material is attached to the head rail. According to another embodiment, the roman shade may further comprise a plurality of secondary carriers attached to opposite sides and between the first end and the second end of the shade material. According to an embodiment, each master carrier may comprise wheels adapted to rotate as the master carrier travels within one of the tracks. According to an embodiment, each master carrier may comprise a carrier connector that extends out of a longitudinal opening in the track, wherein the carrier connectors are used to attach the master carriers to the shade material. The shade material may comprise a pair of shade connectors each adapted to connect to one of the carrier connectors to attach the master carriers to the shade material.

According to an embodiment, the roman shade further comprises at least one support cord having a first end attached to the tube and a second end attached to the shade material proximate to the second end of the shade material. According to an embodiment, each track may comprise a longitudinal channel, wherein each cord is retained within the channel and is substantially concealed from view. According to an embodiment, the roman shade further comprises a plurality of eyelet connectors attached to opposite sides of the shade material, wherein each cord is fed through the eyelet connectors disposed on a respective side of the shade material.

According to a further embodiment, the structural opening may comprise at least two horizontally arranged segments interconnected by at least one middle jamb, and wherein the shade material comprises at least two horizontally arranged shade segments adapted substantially cover the plurality of segments of the structural opening. According to an embodiment, the at least two shade segments may be attached together at their sides to form the shade material. According to another embodiment, the at least two shade segments are made from a single sheet of shade material. According to another embodiment, the roman shade may further comprises: at least one additional longitudinal track adapted to follow a contour of and be attached along the at least one middle jamb; at least one additional master carrier adapted to be retained by and longitudinally travel within the at least one additional track, wherein the at least one additional master carrier is adapted to be attached to and between the at least two shade segments; and at least one additional cord attached to the additional master carrier to lift or lower the additional master carrier within the additional track.

According to another aspect of the embodiment, a roman shade is provided adapted cover a structural opening comprising a top, a bottom, and a pair of sides. The roman shade comprises: a tube adapted to be installed proximate to the top of the structural opening; a shade material comprising and extending between a first end attached proximate to the top of the structural opening and a second end, wherein the shade material comprises a size adapted to substantially cover the structural opening; a longitudinal dowel attached horizontally to the second end of the shade material; a pair of longitudinal tracks each adapted to follow a contour of and be attached along one of the sides of the structural opening; a pair of master carriers attached to opposite ends of the dowel, wherein each master carrier is adapted to be retained by and longitudinally travel within one of the longitudinal tracks; a pair of cords each having a first end attached to the tube and a second end attached to one of the pair of master carriers; and a shade drive unit operably connected to the tube and adapted to rotate the tube to wind or unwind the pair of cords and thereby lift or lower the pair of master carriers within the pair of tracks.

According to yet another aspect of the embodiments, a roman shade is provided adapted cover a structural opening comprising a top, a bottom, and a pair of unparalleled sides such that the structural opening comprises a first width and a second width wider than the first width. The roman shade comprises: a tube adapted to be installed proximate to the top of the structural opening; a shade material comprising and extending between a first end attached proximate to the top of the structural opening and a second end, wherein the shade material comprises a size adapted to substantially cover the structural opening; a pair of longitudinal tracks each adapted to follow a contour of and be attached along one of the sides of the structural opening such that the pair of longitudinal tracks are mounted unparalleled with respect to each other; a pair of master carriers each adapted to be retained by and longitudinally travel within one of the longitudinal tracks; a longitudinal telescoping dowel attached horizontally to the second end of the shade material, wherein the pair of master carriers are attached to opposite ends of the dowel, and wherein the telescoping dowel is adapted to expand or compress as the master carriers travel within the pair of tracks; a pair of cords each having a first end attached to the tube and a second end attached to one of the pair of master carriers; and a shade drive unit operably connected to the tube and adapted to rotate the tube to wind or unwind the pair of cords and thereby lift or lower the pair of master carriers within the pair of tracks, and wherein the shade material is adapted to horizontally extend from a first width that substantially spans the first width of the structural opening to a second width that substantially spans the second width of the structural opening.

### BRIEF DESCRIPTION OF THE DRAWINGS

The above and other objects and features of the embodiments will become apparent and more readily appreciated from the following description of the embodiments with reference to the following figures. Different aspects of the embodiments are illustrated in reference figures of the drawings. It is intended that the embodiments and figures disclosed herein are to be considered to be illustrative rather than limiting. The components in the drawings are not necessarily drawn to scale, emphasis instead being placed upon clearly illustrating the principles of the aspects of the embodiments. In the drawings, like reference numerals designate corresponding parts throughout the several views.

### Brief Description of the Several Views of the Drawings

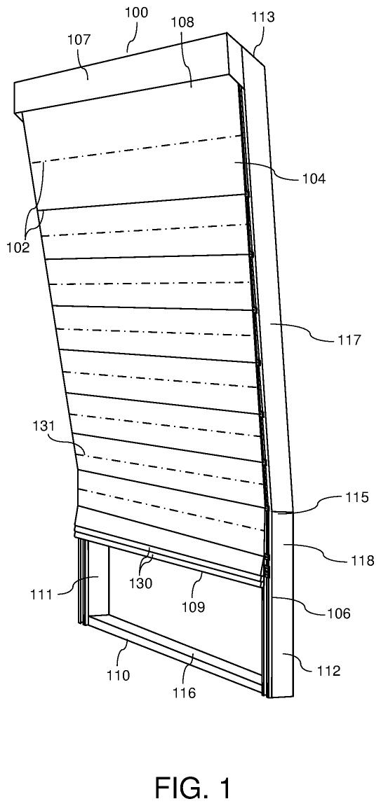

FIG. 1 illustrates a front perspective view of a roman shade installed in a tilted rectangular shaped window according to an illustrative embodiment.

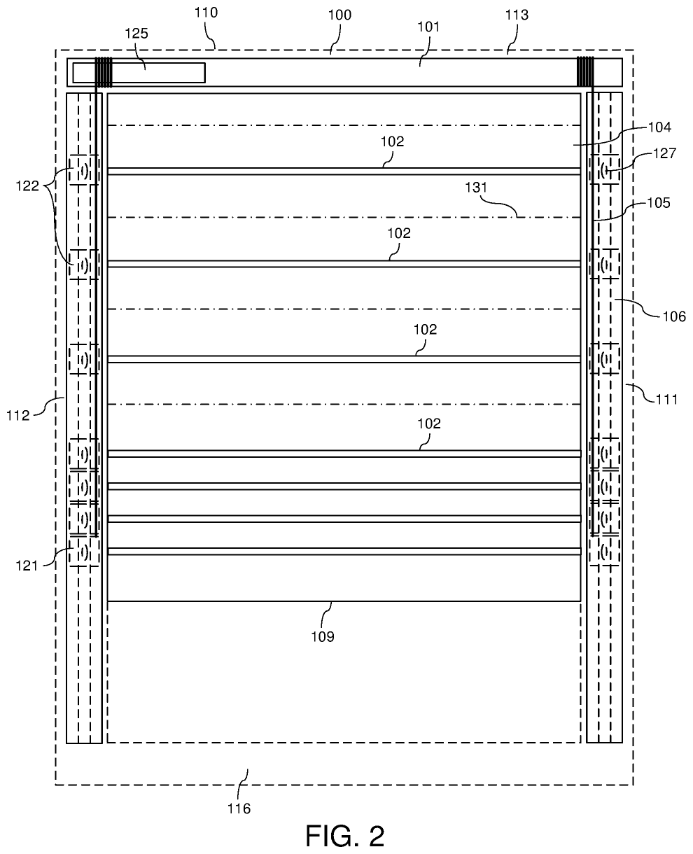

FIG. 2 illustrates a rear view of the roman shade of FIG. 1 according to an illustrative embodiment.

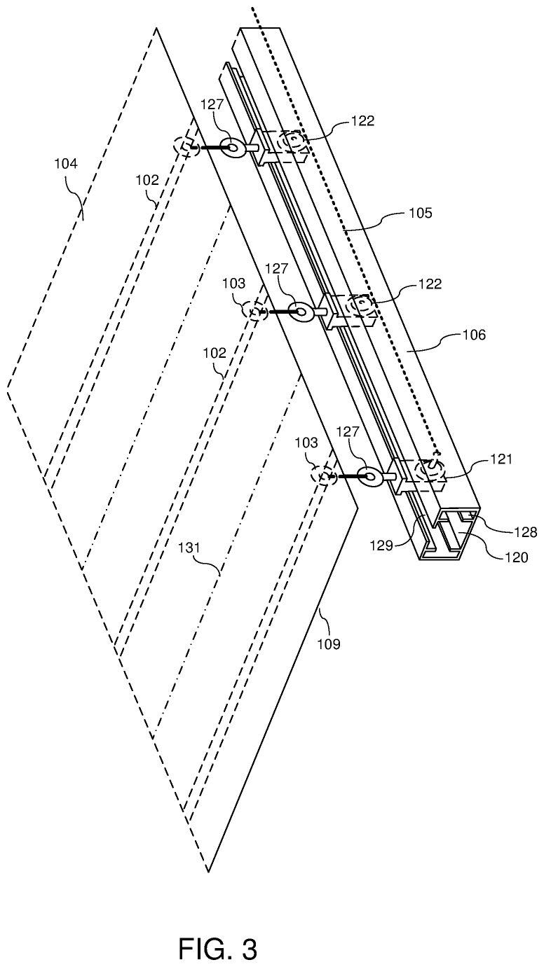

FIG. 3 illustrates a front perspective view of the lift cord to track attachment of the roman shade according to one illustrative embodiment.

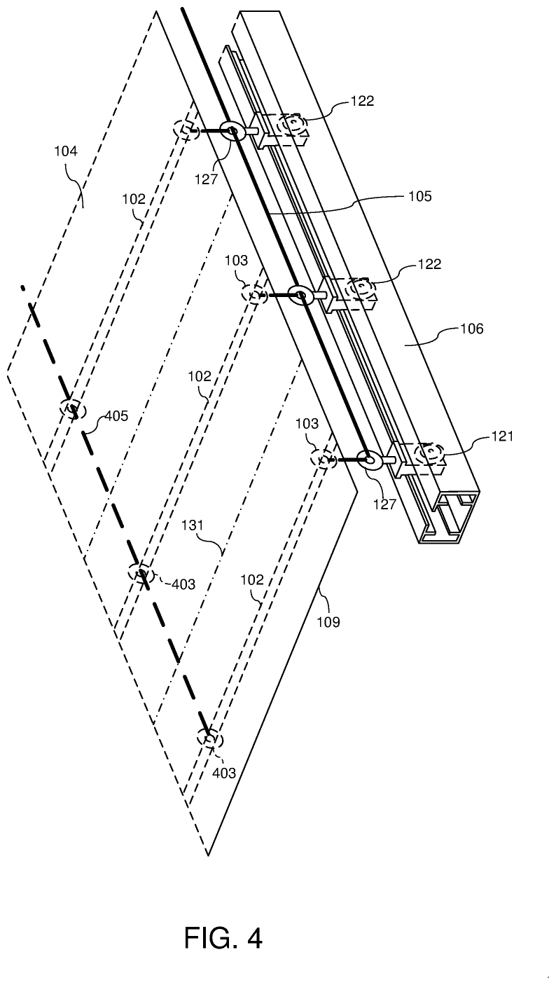

FIG. 4 illustrates a front perspective view of the lift cord to track attachment of the roman shade according to another illustrative embodiment.

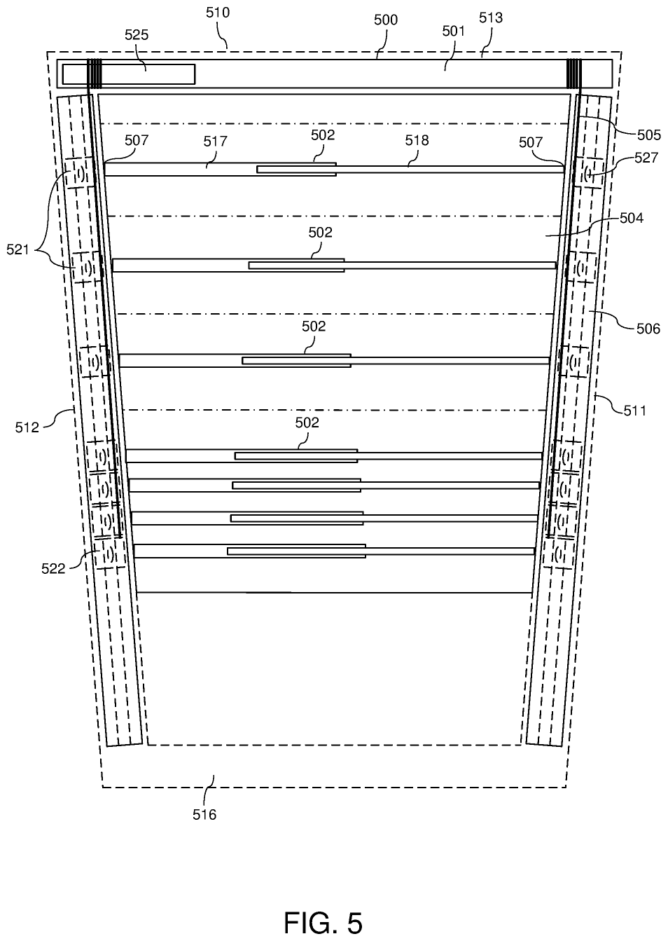

FIG. 5 illustrates a rear view of a roman shade installed in a trapezoid window with a wide head jamb according to one illustrative embodiment.

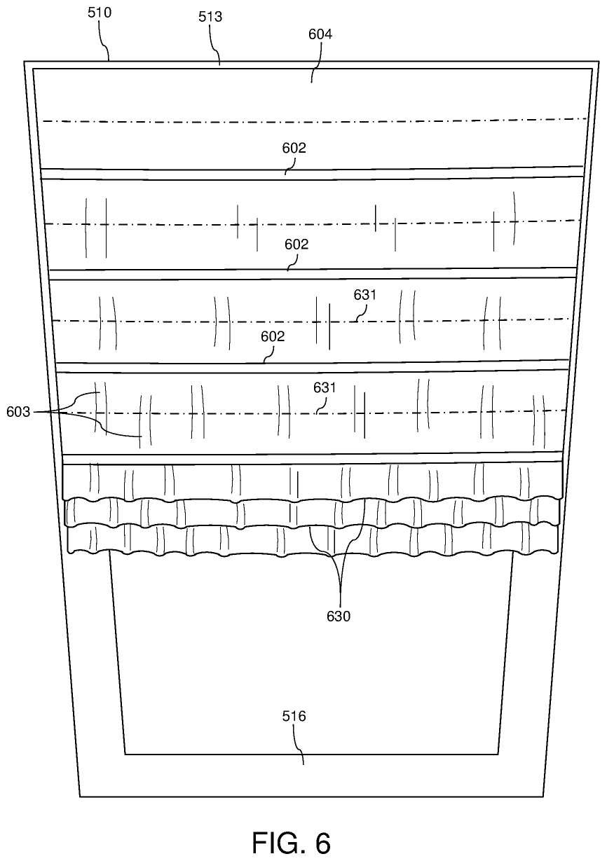

FIG. 6 illustrates a front view of a shade material of the roman shade installed in a trapezoid window with a wide head jamb according to one illustrative embodiment.

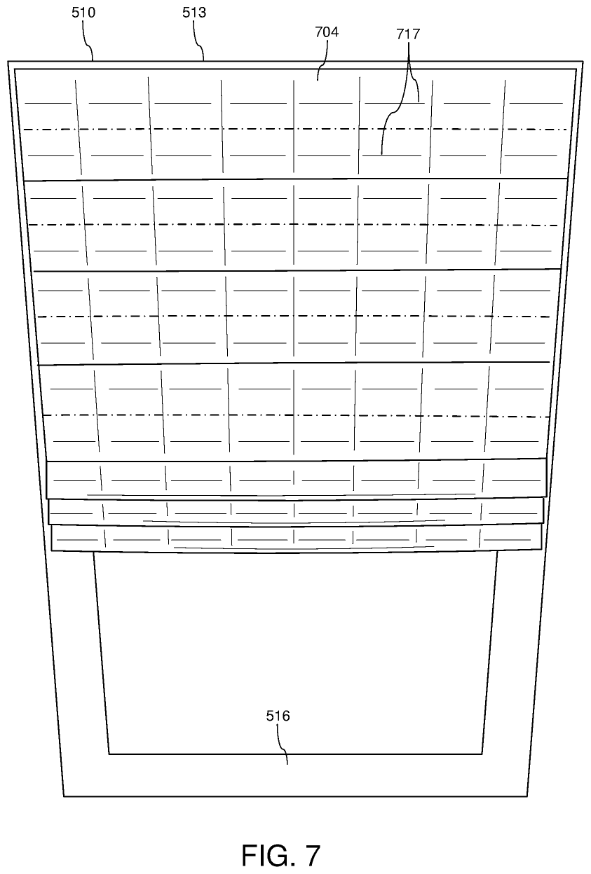

FIG. 7 illustrates a front view of a shade material of the roman shade installed in a trapezoid window with a wide head jamb according to another illustrative embodiment.

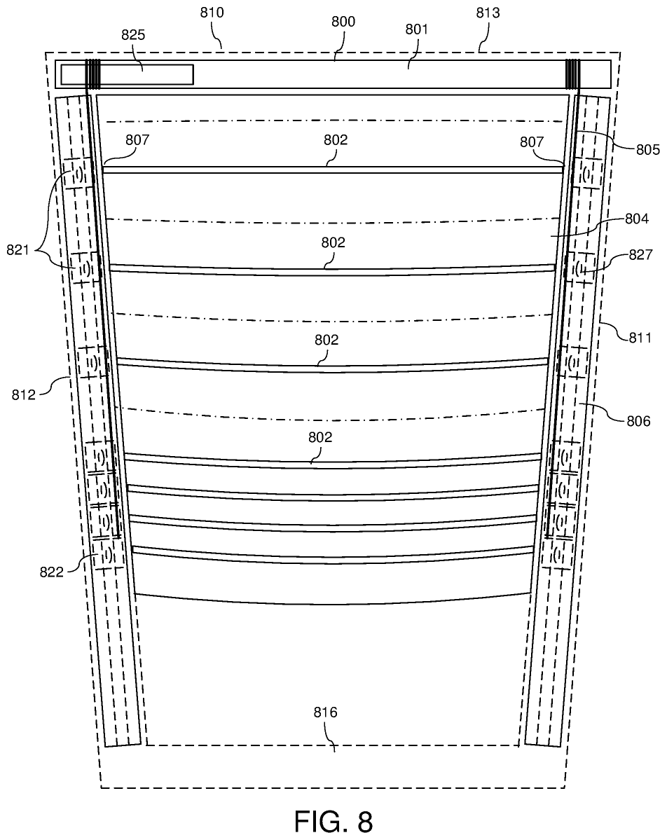

FIG. 8 illustrates a rear view of a roman shade installed in a trapezoid window with a wide head jamb according to another illustrative embodiment.

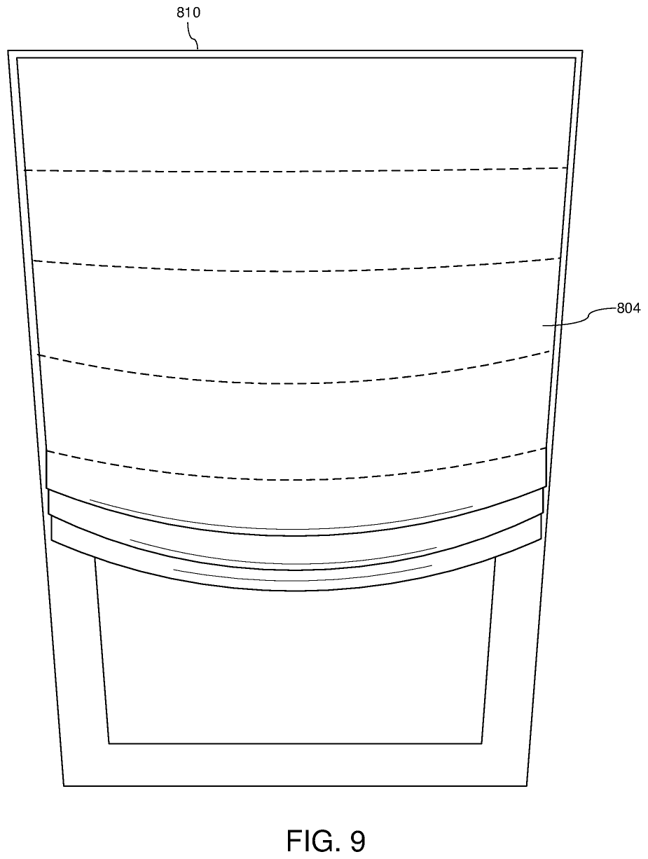

FIG. 9 illustrates a front view of a shade material of the roman shade installed in a trapezoid window with a wide head jamb according to yet another illustrative embodiment.

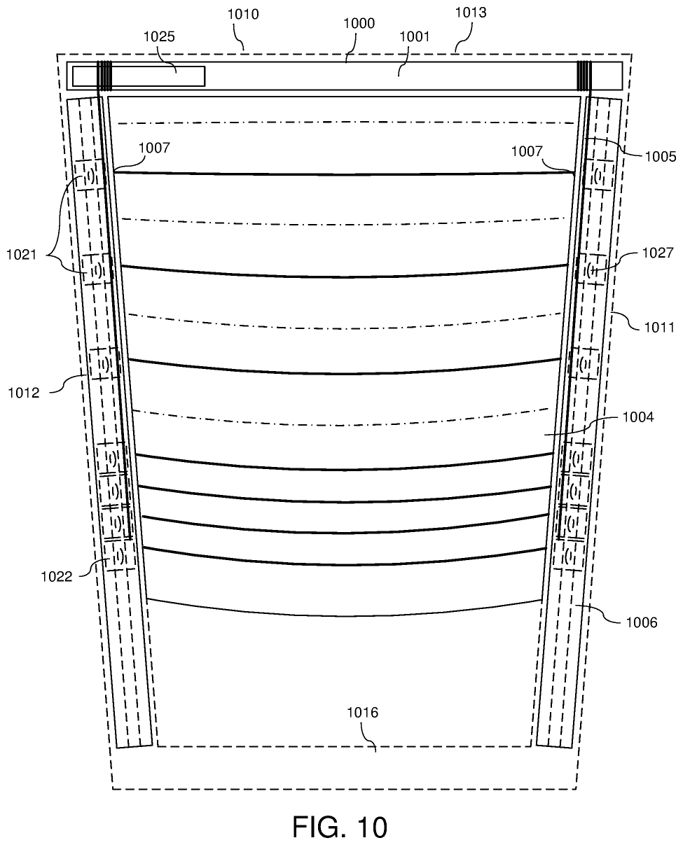

FIG. 10 illustrates a rear view of a roman shade installed in a trapezoid window with a wide head jamb according to yet another illustrative embodiment.

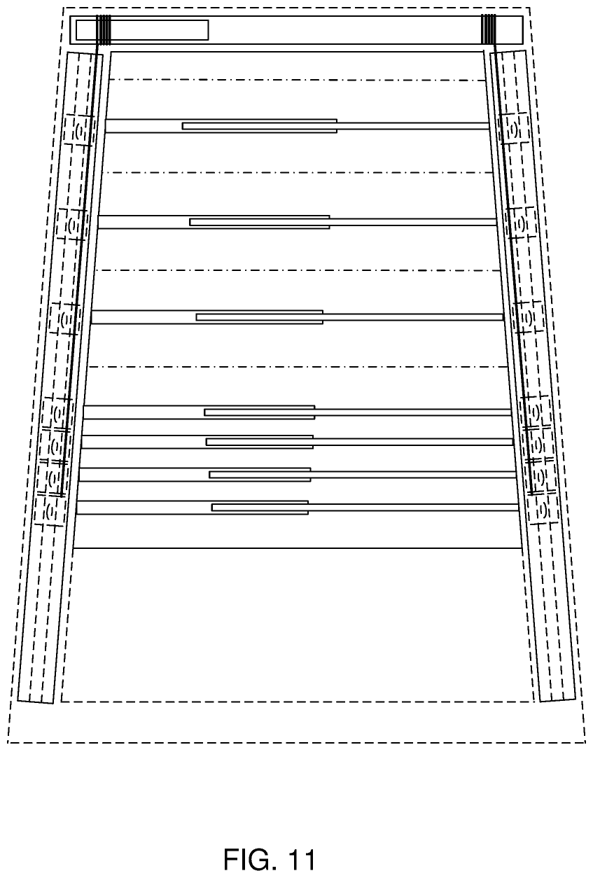

FIG. 11 illustrates a rear view of a roman shade installed in a trapezoid window with a narrow head jamb according to yet another illustrative embodiment.

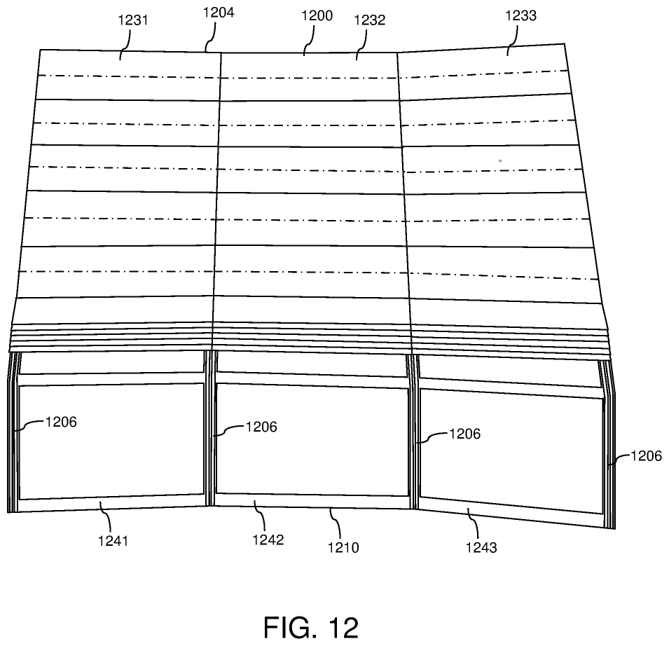

FIG. 12 illustrates a front perspective view of a roman shade installed in a tilted bay window according to an illustrative embodiment.

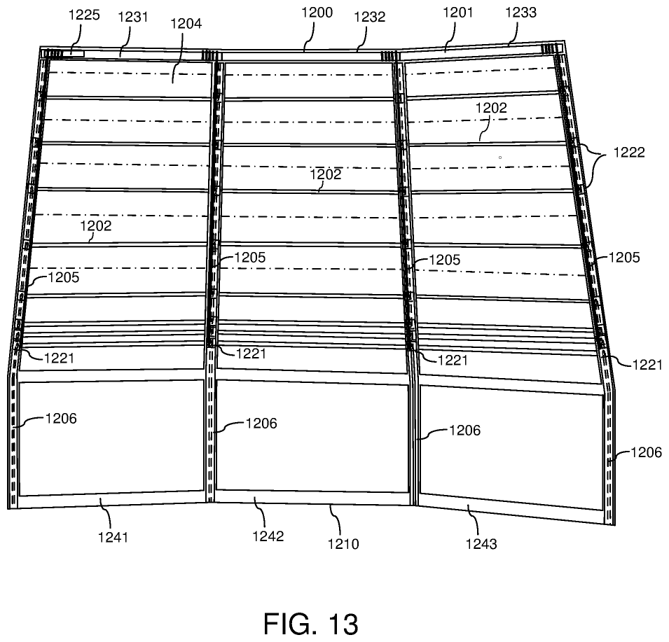

FIG. 13 illustrates a rear view of the roman shade of FIG. 12 according to an illustrative embodiment.

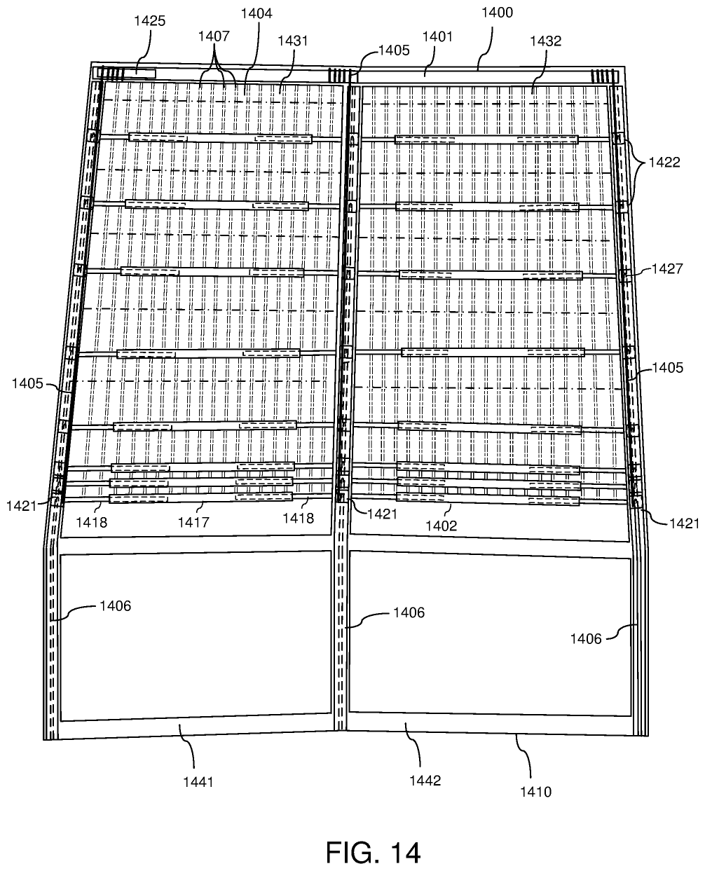

FIG. 14 illustrates a rear view of a roman shade installed in a tilted bay window according to another illustrative embodiment.

### DETAILED DESCRIPTION OF THE INVENTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims. The detailed description that follows is written from the point of view of a control systems company, so it is to be understood that generally the concepts discussed herein are applicable to various subsystems and not limited to only a particular controlled device or class of devices.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” or “in an embodiment” in various places throughout the specification is not necessarily referring to the same embodiment. Further, the particular feature, structures, or characteristics may be combined in any suitable manner in one or more embodiments.

### LIST OF REFERENCE NUMBERS FOR THE ELEMENTS IN THE DRAWINGS IN NUMERICAL ORDER

The following is a list of the major elements in the drawings in numerical order.
100 Roman Shade
101 Roller Tube
102 Dowels
103 Shade Connectors
104 Shade Material
105 Cords
106 Tracks
107 Head Rail
108 Top End
109 Bottom End
110 Window Frame
111 Side Jamb
112 Side Jamb
113 Head Jamb
115 Bend
116 Sill
117 Top Window Segment
118 Bottom Window Segment
120 Center Cavity
121 Master Carriers
122 Secondary Carriers
125 Shade Drive Unit
127 Carrier Connectors
128 Channel
129 Longitudinal Opening
130 Pleats
131 Fold Lines
403 Shade Connectors
405 Supporting Cord
500 Roman Shade
501 Roller Tube
502 Telescoping Dowels
503 Shade Connectors
504 Shade Material
505 Cords
506 Tracks
507 Terminal Ends
510 Window Frame
511 Side Jamb
512 Side Jamb
513 Head Jamb
516 Sill
517 First Rod
518 Second Rod
521 Master Carriers
522 Secondary Carriers
525 Shade Drive Unit
527 Carrier Connectors
602 Horizontal Pockets
603 Vertical Pleats
604 Shade Material
630 Horizontal Pleats
631 Fold Lines
704 Shade Material
717 Weft Threads
800 Roman Shade
801 Roller Tube
802 Flexible Dowels
804 Shade Material
805 Cords
806 Tracks
807 Terminal Ends
810 Window Frame
811 Side Jamb
812 Side Jamb
813 Head Jamb
816 Sill
821 Master Carriers
822 Secondary Carriers
825 Shade Drive Unit
827 Carrier Connectors
1000 Roman Shade
1001 Roller Tube
1004 Shade Material
1005 Cord
1006 Tracks
1007 Terminal Ends
1010 Window Frame
1011 Side Jamb
1012 Side Jamb
1013 Head Jamb
1016 Sill
1021 Master Carriers
1022 Secondary Carriers
1025 Shade Drive Unit
1027 Carrier Connectors
1200 Roman Shade
1201 Roller Tube
1202 Dowels
1204 Shade Material
1205 Cords
1206 Tracks
1210 Window Frame
1221 Master Carriers
1222 Secondary Carriers
1225 Shade Drive Unit
1231-1233 Shade Segments
1241-1243 Window Segments
1400 Roman Shade
1401 Roller Tube
1402 Dowels
1404 Shade Material
1405 Cords
1406 Tracks
1407 Vertical Pleats
1410 Window Frame
1417 Center Rod
1418 Side Rods
1421 Master Carriers
1422 Secondary Carriers
1425 Shade Drive Unit
1427 Carrier Connectors
1431-1332 Shade Segments
1441-1442 Window Segments

### Mode(s) For Carrying Out The Invention

For 40 years Crestron Electronics, Inc. has been the world's leading manufacturer of advanced control and automation systems, innovating technology to simplify and enhance modern lifestyles and businesses. Crestron designs, manufactures, and offers for sale integrated solutions to control audio, video, computer, and environmental systems. In addition, the devices and systems offered by Crestron streamlines technology, improving the quality of life in commercial buildings, universities, hotels, hospitals, and homes, among other locations. Accordingly, the systems, methods, and modes of the aspects of the embodiments described herein can be manufactured by Crestron Electronics, Inc., located in Rockleigh, N.J.

The different aspects of the embodiments described herein pertain to the context of roman shades, but is not limited thereto, except as may be set forth expressly in the appended claims. While the roman shade is described herein for covering a window, the roman shade may be used to cover doors, wall openings, or other openings of a structure. The embodiments described herein may further be adapted in other types of window or door shades, such as roller shades, inverted rollers, Austrian shades, pleated shades, blinds, shutters, skylight shades, garage doors, or the like.

The roman shade of the present embodiments, may be adapted to be mounted in a non-rectangular window, such as a trapezoidal window or a parallelogram window, and may be adapted to be mounted in other oddly shaped windows. In addition, the roman shade of the present embodiments is further adapted to be mounted in windows of different orientations and tilt angles that tilt toward or away from a room, whether square, rectangular, or non-rectangular in shape. In tilted windows, the shade material of the roman shade hangs and travels parallel to the window such that the fabric is sloped at the same angle as the window, resulting in a roman shade that does not encroach or diminish from the living space. The roman shade of the present embodiments can completely cover differently shaped window types for total privacy with the option to have a limited light gap and increased view to achieve the most privacy.

Referring to FIGS. 1 and 2 there is shown one embodiment of a roman shade 100, where FIG. 1 illustrates a front perspective view of the roman shade 100 in a partially opened position and FIG. 2 illustrates a rear view of the roman shade 100. In FIGS. 1 and 2, the roman shade 100 is adapted to be installed in a rectangular window frame 110 that is at least partially tilted towards the room. Roman shade 100 generally comprises shade material 104, a rod or roller tube 101, shade drive unit 125, a pair of cords 105, and a pair of tracks 106.

In various embodiments, the shade material 104 may comprise fabric, plastic, vinyl, or other materials known to those skilled in the art. Shade material 104 may comprise a rectangular shape that is either larger than the window frame 110, for example where the roman shade 100 is mounted in front of the window 110, or that is substantially the same size as the opening of the window frame 110, where the roman shade 100 is mounted within the window frame 110. The shade material 104 comprises a plurality of horizontally arranged dowels 102 that may be attached to the rear surface of the shade material 104. The dowels 102 may be exposed at the rear surface of the shade material 104, or they may be concealed from view. According to an embodiment, lining material may be disposed behind the shade material 104 that conceals the dowels 102 from view. The dowels 102 may also disposed inside pockets or may be covered by shrouds. The dowels 102 may be evenly spaced along the height of the shade material 104, however, uneven spacing may be also utilized. According to various embodiments, the dowels 102 may be made of fiberglass, metal, wood, plastic, composite materials, or the like. Referring to FIG. 3, shade connectors 103 are attached to each end of each of the dowel 102 proximate to the side edges of the shade material 104. Shade connectors 103 may comprise rings, hooks, eyelets, or the like. When the bottom of the shade material 104 is pulled up, the dowels 102 come closer to each other causing pleats 130 to form (FIG. 1) starting at the bottom end of the shade material 104 along fold lines 131.

The roman shade 100 may be mounted to a window frame 110 comprising a pair of side jambs 111 and 112 interconnected at their top ends by a head jamb 113 and at their bottom ends by a sill 116. As an example, window frame 110 may comprise a top window segment 117 that may be tilted towards the room, and a vertical bottom window segment 118 that is orthogonal to the room. However, the roman shade 100 may be mounted in a different window frame, for example, one that is entirely tilted or inclined away from the room.

The roman shade 100 may comprise a head rail or a fascia 107 adapted to be mounted to the window frame 110 or on a wall proximate to the head jamb 113 via mounting brackets (not shown). The top end 108 of the shade material 104 may be attached to the head rail 107. In another embodiment, the top end 108 of the shade material 104 may be attached directly to the head jamb 113. The roller tube 101 may be mounted proximate the head jamb 113 within the head rail 107 such that it is concealed from view via the head rail 107. The roller tube 101 may be generally cylindrical in shape. The head rail 107 may comprise an L shaped or a U shaped cross section with an opening from which the shade material 104 extends out of the head rail 107.

According to various embodiments, the roman shade 100 may comprise a shade drive unit 125 adapted to rotate the roller tube 101. According to one embodiment, the shade drive unit 125 may be at least partially received within the roller tube 101 and may be adapted to rotate the roller tube 101 to raise or lower the shade material 104 to open or close the structural opening, such as a window frame 110. According to another embodiment, instead of a hollow tube 101, the roman shade 100 may comprise a solid tube that is attached to an output of the shade drive unit 125.

The shade drive unit 125 may comprise a mechanical drive assembly for manual or semi-manual operation of the shade 100, for example, allowing adjusting of the shade 100 by pulling on a chain. In an alternative embodiment, the shade drive unit 125 may comprise a motor for motorized operation of the shade as shown in FIG. 2. In a motorized implementation of the roller shade 100, the shade drive unit 125 may include a motor control module, a motor, and a drive wheel that fit within the roller tube 101. The motor control module may comprise fully integrated electronics to control the motor, directing the operation of the motor, including its direction, speed, and position. While the motor remains stationary, the drive wheel may be connected to the output shaft of the motor to rotate the roller tube 101.

The roman shade 100 may further comprise a pair of tracks 106 each secured to respective side jambs 111 and 112, for example via screws. Tracks 106 are adapted to follow the contour of the side jambs 111 and 112. In a window that is simply tilted towards the room, tracks 106 may be straight. In window frame 110 show in FIG. 1, the tracks may be bent at bend 107 to follow the change in tilt of the window frame 110. Accordingly, roman shade 100 may be adapted to be installed in a window frame that includes a plurality of window segments arranged at various tilt angles or a single bent window segment.

Each track 106 may comprise a center cavity 120 (FIG. 3) adapted to receive a plurality of carriers therein, including master carrier 121 and secondary carriers 122. To lower or raise the shade material 104, the carriers 121 and 122 comprise wheels that allow them to travel linearly within the length of the tracks. Each carrier 121 and 122 further comprises a carrier connector 127 adapted to extend out of a longitudinal opening 129 along the track 106. The carriers 121 and 122 are adapted to be attached proximate to the terminal ends of each dowel 102 by connecting carrier connectors 127 to respective shade connectors 103 as shown in FIG. 3. In various embodiments, carrier connectors 127 and shade connectors 103 may comprise rings, hooks, eyelets, or the like, that allow interconnection between the carrier connectors 127 and the shade connectors 103. Accordingly, carriers 121 and 122 are attached at regular intervals along the shade material 104. Tracks 106 in turn are adapted to guide the carriers 121 and 122 and thereby the shade material 104 to follow the profile and tilt of the window frame 110.

A pair of cords 105 may be used to lift or lower the shade material 104, although additional supporting cords may be added for wide spanning shades. The top ends of the cords 105 may be attached to the roller tube 101, each proximate to its opposing terminal ends. As the roller tube 101 rotates, the cords 105 get either wound up or unwound from the roller tube 101 depending on the direction of travel. The bottom ends of the cords 105 may be attached to the master carriers 121. According to an embodiment, each track 106 comprises a channel 128 proximate to the center cavity 120 that is adapted to receive a respective cord 105 therein. The channel 128 may comprise a U shaped profile. As such, each cord 105 extends from the roller tube 101 into the channel 128 of the track 106 where it connects to the master carrier 121 such that it is concealed from view by the track 106. As the cord 105 travels within the channel 128, it is captured by and biased within the channel 128 such that it cannot exit the channel 128.

In operation, to lower the shade material 104, the shade drive unit 125 rotates the roller tube 101 causing the cords 105 to unwind from the roller tube 101 and lower the master carriers 121 along the tracks 106. The master carriers 121 in turn pull the bottom end of the shade material 104 to close the window. To raise the shade material 104, the shade drive unit 125 rotates the roller tube 101 in the opposite direction causing the cords 105 to wind onto the roller tube 101 and raise the master carriers 121 along the tracks 106. The master carriers 121 in turn pull the bottom end of the shade material 104 to open the window. As the dowels 102 are raised and come closer to each other, pleats 130 are formed starting at the bottom of the shade material 104 along fold lines 131.

Referring to FIG. 4, according to another embodiment, instead of feeding the cords 105 through the channels 128 in the side tracks 106, the cords 105 may be instead fed through, but not attached to, the eyelet carrier connectors 127 of the secondary carriers 122 and be attached to the eyelet carrier connector 127 of the master carrier 121. According to a further embodiment, one or more additional supporting cords 405 may be included and may be disposed and attached to the shade material 104 at regular intervals between the pair of side cords 105. The bottom end of each supporting cord 405 may be attached to a shade connector 403, which is attached to the bottommost dowel 102. The top end of each of the supporting cord 405 may be attached to the roller tube 101. The supporting cords 405 may be fed through the eyelet shade connectors 403 that are attached to the dowels 102 disposed above the bottommost dowel 102. During operation, as the roller tube 101 rotates, the supporting cords 405 get either wound up or unwound from the roller tube 101, depending on the direction of travel, to raise or lower the bottommost dowel 102 and thereby the shade material 104.

FIG. 5 illustrates another embodiment of the roman shade 500 adapted to be installed in non-rectangular window frame 510 with unparalleled side jambs 511 and 512. Window frame 510 may comprise a trapezoidal shape with parallel head jamb 513 and sill 516 and upwardly slanted side jambs 511 and 512, such that the head jamb 513 is wider than the sill 516. However, roman shade 500 may be adapted to be installed in window frames of other configurations, including trapezoidal window frames with head jamb that is narrower than the sill (e.g., FIG. 11), parallelogram window frames, as well as window frames that are also tilted or inclined away from or towards a room. Roman shade 500 may comprise configuration substantially similar to roman shade 100 discussed above, including shade material 504, a hollow or solid roller tube 501, shade drive unit 525, a pair of cords 505, and a pair of tracks 506 with lineally traveling carriers 521/522 disposed therein. Tracks 506 are mounted along the length of the side jambs 511 and 512 and thereby follow the orientation and angle of the side jambs 511 and 512.

Roman shade 500 comprises a plurality of horizontally arranged telescoping dowels 502 disposed at the rear surface of the shade material 504 at substantially regular intervals to create horizontal pleats in the shade material 504 as discussed above. According to an embodiment, the terminal ends 507 of the telescoping dowels 502 may be attached to the sides of the shade material 504. Each telescoping dowel 502 may comprise a first hollow rod 517 and a second hollow or solid rod 518 adapted to telescopingly fit within the first hollow rod 517 such that the telescoping dowel 502 can horizontally expand and compress. As the shade material 504 is raised or lowered, the carriers 521 and 522 linearly travel along the tracks 506 substantially along and parallel to respective side jambs 511 and 512 of the window frame 510. Because the horizontal distance between the side jambs 511 and 512, pair of tracks 506, and thereby each respective pair of carriers 521/522 changes as the dowels 502 travel with respect to side tracks 506, the carrier connectors 527 pull or push on the shade connectors 503 causing the telescoping dowels 502 to either expand or compress, depending on the direction of travel.

According to an embodiment, the shade material 504 may comprise a rectangular shape comprising a width that spans the width of the window head jamb 513 (i.e., it corresponds to the wider base of the trapezoidal shape). Referring to FIG. 6, the shade material 604 may contain horizontal pockets 602 or a horizontal shroud tape adapted to enclose the telescoping dowels 502 therein. In other embodiments, instead of having solid pockets, the telescoping dowels 502 may be secured to the shade material 604 using strips or rings. At the top of the window frame 510 proximate to the head jamb 513, the shade material 604 may lay flat. As the shade material 604 travels towards the bottom of the window frame 510, the shade material 604 may bunch up and create vertical pleats 603 as the distance between the side jambs becomes smaller and the telescoping dowels 502 get compressed. In addition, as the dowels 502 are raised and come closer to each other, horizontal pleats 630 are formed starting at the bottom of the shade material 604 along fold lines 631.

According to an alternative embodiment, with reference to FIG. 7, shade material 704 may comprise a stretchable material. Shade material 704 may comprise a rectangular shape with a width that spans the width of the window sill 516 in an un-stretched relaxed state (i.e., it corresponds to the shorter base of the trapezoidal shape). Shade material 704 may comprise stretchable material that is capable to be stretched out horizontally from a first width that substantially spans the width of the window sill 516 to a second width that substantially spans the width of the window head jamb 513. For example, the shade material 704 may comprise elastic weft threads 717 allowing the shade material 704 to stretch horizontally. As the shade material 704 is raised from a closed position and the telescoping dowels 502 expand, the shade material 704 may stretch to follow the shape of the window frame 510.

In another embodiment, instead of a stretchable shade material 704, shade material may include vertical pleats that allow the shade material to unfold and expand horizontally (such as in FIG. 14 discussed below). The shade material may include elastic members, such as elastic straps, that creates the vertical pleat as the shade material gets more slack. The elastic members may be attached to the back of each of these fold locations and will gather in the shade material to create pleats in vertical direction before the shade material folds and pleats in the horizontal direction.

Referring to FIG. 8, there is shown another embodiment of the roman shade 800 adapted to be installed in non-rectangular window frame, such as a trapezoidal window frame 810 with unparalleled side jambs 811 and 812. Roman shade 800 may comprise configuration substantially similar to roman shade 100 discussed above, including shade material 804, a tube 801, shade drive unit 825, a pair of cords 805, and a pair of tracks 806 with lineally traveling carriers 821/822 disposed therein. The pair of tracks 806 are mounted along the length of the side jambs 811 and 812 and thereby follow the orientation and angle of the side jambs 811 and 812.

Roman shade 800 comprises a plurality of horizontally arranged flexible dowels 802 attached to the rear surface of the shade material 804 at substantially regular intervals to create horizontal pleats in the shade material 804 as discussed above. The terminal ends 807 of the dowels 802 may be attached to the sides of the shade material 804. The shade material 804 may contain horizontal pockets or a horizontal shroud tape adapted to enclose the dowels 802 therein. The dowels 802 may comprise flexible material, such as fiber glass, such that dowels 802 may bend or deflect to form arcs. The shade material 804 may comprise a rectangular shape with a width that spans the width of the window head jamb 813 (i.e., the wider base of the trapezoid shaped window frame). As the shade material 804 is raised or lowered, and the horizontal distance between the tracks 806, and thereby each respective pair of carriers 821/822 changes as the dowels 802 travel with respect to side tracks 806, the carrier connectors 827 pull or push on the shade connectors causing the flexible dowels 802 to either bend or unbend, depending on the direction of travel. Referring to FIG. 9, the shade material 804 will as a result drape or sag down as it reaches the bottom of the window frame 810. Each drape will follow the deflected shape of its corresponding flexible dowel 802.

According to yet another embodiment, referring to FIG. 10, the roman shade 1000 may not include any dowels, but instead the shade material 1004 may be supported by and freely hang between each pair of carriers 1021/1022. Specifically, the terminal ends 1007 of the shade material at each fold location may include shade connectors (such as shade connectors 103) adapted to be attached to carrier connectors 1027 of respective carriers 1021/1022 (as shown in FIG. 3 or 4). As the shade material 1004 is raised or lowered, and the horizontal distance between the tracks 1006 and thereby each respective pair of carriers 1021/1022 changes, the carrier connectors 1027 pull or push on the shade connectors to stretch or unstretch the shade material 1004. The shade material 1004 will as a result drape down or sag as it reaches the bottom of the window frame (similar to FIG. 9 but with more lax).

Referring to FIG. 12, the roman shade 1200 of the present embodiments may be configured to be installed in a window frame 1210 of a bay type window which may comprise a plurality of horizontally arranged window segments of different shapes and tilt angles, such as three segments 1241-1243. In such a configuration, the shade material 1204 may comprise a plurality of interconnected shade segments 1231-1233. The shade segments 1231-1233 may be attached, such as by being sewn together, to appear as a single window treatment covering. Each shade segment 1231-1233 may be adapted to cover the opening of a corresponding window segment 1241-1243 and therefore may be of different size and tilt angle orientation to correspond to the window frame segments 1241-1243. In another embodiment, the shade segments 1231-1233 may be made from a single sheet of material, with a width that spans the combined widest width of the window segments 1241-1243.

Each shade segment 1231-1233 may contain dowels 1202 secured to its rear surface at regular vertical intervals. Dowels 1202 may have any of the dowel configurations discussed above depending on the window shape and the desired shade effect. A plurality of tracks 1206 with linearly traveling carriers 1221/1222 and lifting cords 1205 may be secured to the side and middle jambs of the plurality of window segments 1201-1203. Any two adjacent shade segments 1231-1233 may share the same track 1206 and be attached to the carriers 1221/1222 running on the shared track 1206. Particularly, the shade connectors (103) of two adjacent dowels 1202 of two adjacent shade segments (e.g., 1231 and 1232) may be both attached to a respective carrier 121/122, for example via a carrier connector (127), which is disposed between the two adjacent shade segments 1231 and 1232. According to another embodiment, any two adjacent dowels 1202 may be interconnected via a dowel bracket that may contain a pair of interconnected hollow rods adapted to receive the terminal ends of the two adjacent dowels 1202. The dowel bracket may be an angled bracket comprising an angle between the pair of interconnected hollow rods that corresponds to the angle between the respective adjacent window segments 1241-1242, or it may comprise a hinged bracket with an adjustable angle. The dowel bracket may be connected to the respective carrier 1221/1222, for example via a carrier connector (127) and to the shade material 1204, for example via a shade connector (103), between the respective shade segments 1231-1232. A single or a plurality of roller tubes 1201 may be driven by single or a plurality of shade drive units 1225 to raise or lower the shade material 1204 using a plurality cords 1205. Using a single shade material 1204 construction allows for clean window coverage that is uniformly controllable.

Referring to FIG. 14, there is shown a rear view of another embodiment of roman shade 1400, for example installed in a window frame 1410 of a bay type window with a plurality of horizontally arranged window segments of different shapes and tilt angles, such as two segments 1441-1442. Shade material 1404 may comprise a single sheet of material defined by two shade segments 1431-1432 adapted to cover and span the openings of window segments 1441-1442. Shade material 1404 may comprise a corrugated fabric formed with vertical pleats 1407 such that it can be horizontally expended to cover the widest portion of each window segment 1441-1442. Vertical pleats 1407 may be formed of fabric material capable of holding the shape of the pleats when pressed—such as cotton, wool, silk, or the like. According to another embodiment, elastic bands may be included to assist in holding the shape of the shade material 1404. As discussed above, a plurality of tracks 1406 with linearly traveling carriers 1421/1422 and lifting cords 1405 may be secured to the side and middle jambs of the plurality of window segments 1401-1402. As discussed above, additional supporting lifting cords (405) may be disposed at regular intervals and attached to the shade material 1404. Shade material 1404 may be attached to the carriers 1421/1422 running on track 1406 at points where two adjacent shade segments 1431-1432 meet.

Each shade segment 1431-1432 may contain dowels 1402 secured to its rear surface at regular intervals. According to an embodiment, the terminal ends of the dowels 1402 may be attached to the sides of the corresponding shade segments 1431-1432 of the shade material 1404. Two adjacent dowels 1402 of the two adjacent shade segments 1341 and 1342) may be both attached to a respective carrier 1421/1422, for example via a shade (103) and carrier connector (127), or via dowel brackets, as discussed above with reference to FIG. 12. Dowels 1402 may have any of the dowel configurations discussed above depending on the window shape and the desired shade effect. According to another embodiment, dowels 1402 may comprise a plurality of horizontally arranged telescoping dowels. Each telescoping dowel 1402 may comprise a center hollow rod 1417 and a pair of hollow or solid side rods 1418 adapted to telescopingly extend from the terminal ends of the center hollow rod 1417 such that the telescoping dowel 1402 can horizontally expand and compress.

A single or a plurality of roller tubes 1401 may be driven by single or a plurality of shade drive units 1425 to raise or lower the shade material 1404 using the plurality cords 1405. Using a single shade material 1404 construction allows for clean window coverage that is uniformly controllable. As the shade material 1404 is raised or lowered, the carriers 1421 and 1422 longitudinally travel along the tracks 1406 substantially along and parallel to respective side jambs of the window frame 1410. Because the horizontal distance between any two side jambs, any two pairs of tracks 1406, and thereby each respective pair of carriers 1421/1422 changes as the dowels 1402 travel with respect to side tracks 1406, the carrier connectors 1427 pull or push on the shade connectors (103) causing the telescoping dowels 1402 to either expand or compress, depending on the direction of travel.

### INDUSTRIAL APPLICABILITY

The disclosed embodiments provide a system and a method for a roman shade for a non-rectangular window, such as a trapezoidal or a parallelogram window, and which may be mounted in different orientations and tilt angles. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Although the features and elements of aspects of the embodiments are described being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

Additionally, the various methods described above are not meant to limit the aspects of the embodiments, or to suggest that the aspects of the embodiments should be implemented following the described methods. The purpose of the described methods is to facilitate the understanding of one or more aspects of the embodiments and to provide the reader with one or many possible implementations of the processed discussed herein. The steps performed during the described methods are not intended to completely describe the entire process but only to illustrate some of the aspects discussed above. It should be understood by one of ordinary skill in the art that the steps may be performed in a different order and that some steps may be eliminated or substituted.

All United States patents and applications, foreign patents, and publications discussed above are hereby incorporated herein by reference in their entireties.

### ALTERNATE EMBODIMENTS

Alternate embodiments may be devised without departing from the spirit or the scope of the different aspects of the embodiments.

What is claimed is:

1. A roman shade adapted cover a structural opening comprising a top, a bottom, and a pair of sides, wherein the roman shade comprises:
a tube adapted to be installed proximate to the top of the structural opening;
a shade material comprising and extending between a first end attached proximate to the top of the structural opening and a second end, wherein the shade material comprises a size adapted to substantially cover the structural opening;
a pair of longitudinal tracks each adapted to follow a contour of and be attached along one of the sides of the structural opening;
a pair of master carriers attached to opposite sides of and proximate to the second end of the shade material, wherein each master carrier is adapted to be retained by and longitudinally travel within one of the longitudinal tracks;
a pair of cords each having a first end attached to the tube and a second end attached to one of the pair of master carriers; and
a shade drive unit operably connected to the tube and adapted to rotate the tube to wind or unwind the pair of cords and thereby lift or lower the pair of master carriers within the pair of tracks.

2. The roman shade of claim 1 further comprising a dowel attached horizontally proximate to the second end of the shade material and wherein the pair of master carriers are attached to opposite ends of the dowel.

3. The roman shade of claim 2, wherein the dowel is attached to the shade material via at least one selected from the group consisting of a horizontal pocket, a horizontal shroud tape, one or more strips, one or more rings, and any combinations thereof.

4. The roman shade of claim 2, wherein the pair of tracks are adapted to be mounted unparalleled with respect to each other in a structural opening in which the pair of sides are unparalleled such that the structural opening comprises a first width and a second width wider than the first width.

5. The roman shade of claim 4, wherein the dowel comprises a telescoping dowel adapted to expand or compress as the master carriers travel within the pair of tracks.

6. The roman shade of claim 4, wherein the shade material is adapted to horizontally extend from a first width that substantially spans the first width of the structural opening to a second width that substantially spans the second width of the structural opening.

7. The roman shade of claim 4, wherein the shade material comprises a rectangular shape comprising a width that substantially spans the second width of the structural opening, and wherein the shade material is adapted to create vertical pleats as the telescoping dowel gets compressed.

8. The roman shade of claim 4, wherein the shade material comprises a stretchable material adapted to stretch out horizontally from a first width that substantially spans the first width of the structural opening to a second width that substantially spans the second width of the structural opening.

9. The roman shade of claim 4, wherein the shade material comprises vertical pleats adapted to unfold to horizontally extend the shade material from a first width that substantially spans the first width of the structural opening to a second width that substantially spans the second width of the structural opening.

10. The roman shade of claim 4, wherein the dowel comprises a flexible dowel adapted to bend and unbend as the master carriers travel within the pair of tracks.

11. The roman shade of claim 1, wherein each of the pair of tracks is adapted to be bent to follow the contour of one of the sides of the structural opening that has a corresponding bend.

12. The roman shade of claim 1 further comprises a plurality of secondary carriers attached to opposite sides and between the first end and the second end of the shade material.

13. The roman shade of claim 1, wherein each master carrier comprises a carrier connector that extends out of a longitudinal opening in the track, wherein the carrier connectors are used to attach the master carriers to the shade material.

14. The roman shade of claim 13, wherein the shade material comprises a pair of shade connectors each adapted to connect to one of the carrier connectors to attach the master carriers to the shade material.

15. The roman shade of claim 1 further comprises at least one support cord having a first end attached to the tube and a second end attached to the shade material proximate to the second end of the shade material.

16. The roman shade of claim 1, wherein each track comprises a longitudinal channel, wherein each cord is retained within the channel and is substantially concealed from view.

17. The roman shade of claim 1 further comprises a plurality of eyelet connectors attached to opposite sides of the shade material, wherein each cord is fed through the eyelet connectors disposed on a respective side of the shade material.

18. The roman shade of claim 1, wherein the structural opening comprises at least two horizontally arranged segments interconnected by at least one middle jamb, and wherein the shade material comprises at least two horizontally arranged shade segments adapted substantially cover the plurality of segments of the structural opening.

19. The roman shade of claim 18, wherein the at least two shade segments are attached together at their sides to form the shade material.

20. The roman shade of claim 18, wherein the at least two shade segments are made from a single sheet of shade material.

21. The roman shade of claim 18, further comprises:
at least one additional longitudinal track adapted to follow a contour of and be attached along the at least one middle jamb;
at least one additional master carrier adapted to be retained by and longitudinally travel within the at least one additional track, wherein the at least one additional master carrier is adapted to be attached to and between the at least two shade segments; and
at least one additional cord attached to the additional master carrier to lift or lower the additional master carrier within the additional track.

22. A roman shade adapted cover a structural opening comprising a top, a bottom, and a pair of sides, wherein the roman shade comprises:
a tube adapted to be installed proximate to the top of the structural opening;
a shade material comprising and extending between a first end attached proximate to the top of the structural opening and a second end, wherein the shade material comprises a size adapted to substantially cover the structural opening;
a longitudinal dowel attached horizontally to the second end of the shade material;
a pair of longitudinal tracks each adapted to follow a contour of and be attached along one of the sides of the structural opening;
a pair of master carriers attached to opposite ends of the dowel, wherein each master carrier is adapted to be retained by and longitudinally travel within one of the longitudinal tracks;
a pair of cords each having a first end attached to the tube and a second end attached to one of the pair of master carriers; and
a shade drive unit operably connected to the tube and adapted to rotate the tube to wind or unwind the pair of cords and thereby lift or lower the pair of master carriers within the pair of tracks.

23. A roman shade adapted cover a structural opening comprising a top, a bottom, and a pair of unparalleled sides such that the structural opening comprises a first width and a second width wider than the first width, wherein the roman shade comprises:
a tube adapted to be installed proximate to the top of the structural opening;
a shade material comprising and extending between a first end attached proximate to the top of the structural opening and a second end, wherein the shade material comprises a size adapted to substantially cover the structural opening;
a pair of longitudinal tracks each adapted to follow a contour of and be attached along one of the sides of the structural opening such that the pair of longitudinal tracks are mounted unparalleled with respect to each other;
a pair of master carriers each adapted to be retained by and longitudinally travel within one of the longitudinal tracks;
a longitudinal telescoping dowel attached horizontally to the second end of the shade material, wherein the pair of master carriers are attached to opposite ends of the dowel, and wherein the telescoping dowel is adapted to expand or compress as the master carriers travel within the pair of tracks;
a pair of cords each having a first end attached to the tube and a second end attached to one of the pair of master carriers; and
a shade drive unit operably connected to the tube and adapted to rotate the tube to wind or unwind the pair of cords and thereby lift or lower the pair of master carriers within the pair of tracks, and wherein the shade material is adapted to horizontally extend from a first width that substantially spans the first width of the structural opening to a second width that substantially spans the second width of the structural opening.
